(19) United States
(12) Patent Application Publication
(10) Pub. No.: US 2011/0295555 A1
(43) Pub. Date: Dec. 1, 2011

(54) Method and System for Determining a Lithographic Process Parameter

(75) Inventors: Hieronymus Johannus Christiaan Meessen, Eindhoven (NL); Christine Corinne Mattheus, Veldhoven (NL); Christian Marinus Leewis, Maastricht (NL)

(73) Assignee: ASML Netherlands B.V., Veldhoven (NL)

(21) Appl. No.: 13/120,751

(22) PCT Filed: Sep. 15, 2009
(86) PCT No.: PCT/EP09/06652

§ 371 Date: Aug. 11, 2011

Related U.S. Application Data
(60) Provisional application No. 61/101,415, filed on Sep. 30, 2008.

(51) Int. Cl. G06F 17/18; G01N 23/225

(52) U.S. Cl. 702/179; 250/310

(57) ABSTRACT

The present invention relates to a method for determining parameter value related to a lithographic process by which a marker structure has been applied on a product substrate based on obtaining calibration measurement data, with an optical detection apparatus, from a calibration marker structure set on a calibration substrate, including at least one calibration marker structure created using different known values of the parameter. The method further determines a mathematical model by using said known values of said at least one parameter and by employing a regression technique on said calibration measurement data, obtains product measurement data, with said optical detection apparatus, from a product marker structure on the product substrate, with at least one product marker structure being exposed with an unknown value of said at least one parameter. Furthermore, the method determines the unknown value of at least one parameter for the product substrate from the obtained product measurement data, wherein the optical detection apparatus may be a SEM and the obtained data includes an image obtained by the SEM.

### CROSS-REFERENCE TO RELATED APPLICATIONS

This application claims the benefit of U.S. provisional application 61/101,415, which was filed on Sep. 30, 2008, and which is incorporated herein in its entirety by reference.

### FIELD

The present invention relates to systems and methods for determining at least one process parameter value related to a lithographic process. The invention also relates to systems and methods of measuring at least one process parameter of a lithographic process by which a target pattern has been printed on a substrate to be tested.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., comprising part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction) while synchronously scanning the substrate parallel or anti-parallel to this direction. It is also possible to transfer the pattern from the patterning device to the substrate by imprinting the pattern onto the substrate.

The trend towards smaller design features and higher device densities requires high resolution lithography. In order to meet the requirements, it is desirable to control the lithographic process. Important process parameters that may need accurate monitoring and control include exposure dose and focus. Generally the critical dimension (CD) variations are measured to monitor and control these parameters. However, it may be difficult to discriminate between dose and focus data when measuring CD-variations.

In order to monitor the lithographic process, it is therefore desirable to measure the relevant process parameters of the patterned substrate, for example the overlay error between successive layers formed in or on it. There are various techniques for making measurements of the small structures formed in lithographic processes, including the use of various inspection tools. One form of inspection tool is a scatterometer in which a beam of radiation (beam spot diameter typically between 25 and 50 micrometer) is directed onto a target on the surface of the substrate and properties of the scattered or reflected beam are measured. By comparing the properties of the beam before and after it has been reflected or scattered by the substrate, the properties of the substrate can be determined. This can be done, for example, by comparing the reflected beam with data stored in a library of known measurements associated with known substrate properties. Two main types of scatterometres are known. Spectroscopic scatterometers direct a broadband radiation beam onto the substrate and measure the spectrum (intensity as a function of wavelength) of the radiation scattered into a particular narrow angular range. Angularly resolved scatterometers use a monochromatic radiation beam and measure the intensity of the scattered radiation as a function of angle. A process known as Principal Component Analysis is a known mathematical method used to obtain, for example, focus, dose and optionally contrast information from scatterometry pupil data without the need for a computationally-intensive reconstruction of the target being measured. This is achieved by printing a calibration array of targets on a test substrate at different dose, focus and optionally contrast values. Scatterometry measurements are then performed on each target in the array. The measurement results are then decomposed into a set of orthogonal basis functions—known as the principal component functions, which depend on the target pattern used, and coefficient values, known as the principal component values. Statistical techniques may then be used to establish a relationship between the nominal focus, dose and optionally contrast values used to print the targets and the principal component values. To derive focus, dose and optionally contrast values for a target printed in a production target, a scatterometry measurement is made, the principal component values are determined and the derived relationship is applied. Further details of this technique can be found in U.S. patent application Publication 2005/0185174 A1, which is hereby incorporated in its entirety by reference.

The relationship between the principal component values and focus, dose and contrast values is dependent on the structure underlying the target. Thus, the calibration array must be printed on the substrate and measured in each layer in which targets are to be measured in each manufacturing process. Generally it is not possible to reuse the relationship derived from one layer in one process in a different layer or process.

If, for instance, in a quality test the unknown focus and dose are to be determined that have been used in a lithographic operation, the substrate to be tested (i.e. the test substrate, or, more generally, the product substrate) is subjected to a measurement operation by a scatterometer, resulting in scatterometry data, herein also referred to as the pupil data or pupil of the substrate. This pupil is compared mathematically to the interpolated model of a plurality of different pupils of a calibration wafer, wherein each pupil is the result of the calibration substrate exposed using a different known focus and known exposure dose value. The focus and dose of the belonging to the best matching pupil is assumed to be the focus and dose of the test substrate.

A limitation of the known method is that substrate features that cannot easily be measured with a scatterometer, for instance non-periodic features, certain complex 2D features, e.g., contact holes or brick walls, or features that are much smaller than the beam spot size are not suitable or less so for an accurate focus and exposure dose determination. In case of non-periodic features the scatterometry data is not usable, because a scatterometer needs a periodic structure repeating the feature at least a couple of times.

### SUMMARY

It is desirable to provide an improved system and method for determining at least one process parameter value related to a lithographic process by which a marker structure has been applied on a product substrate.

It is furthermore desirable to provide an improved method and system for measuring at least one process parameter of a lithographic process by which a target pattern has been printed on a substrate to be tested.

In an embodiment of the present invention, there is provided a method for determining at least one process parameter value related to a lithographic process by which a marker structure has been applied on a product substrate, the method including obtaining calibration measurement data with an optical detection apparatus from at least one calibration marker structure set provided on a calibration substrate, a calibration marker structure set including at least one calibration marker structure created using different known values of said at least one process parameter. The method continues by determining a mathematical model by using known values of said at least one process parameter and by employing a regression technique on the calibration measurement data, the mathematical model comprising a number of regression coefficients. Furthermore, the method continues by obtaining product measurement data, with the optical detection apparatus, from at least one product marker structure provided on the product substrate, with at least one product marker structure being exposed with an unknown value of said at least one process parameter; and determining the unknown value of at least one process parameter for the product substrate from said obtained product measurement data by employing regression coefficients of the mathematical model, where the optical detection apparatus comprises a scanning electron microscope (SEM) and where the obtained calibration measurement data and product measurement data comprise one or more images obtained by the scanning electron microscope (SEM).

In another embodiment of the present invention invention a method of measuring at least one process parameter of a lithographic process by which a target pattern, for instance a calibration marker or similar structure, has been printed on a substrate to be tested, is provided, the method including projecting an image of a reference pattern onto a radiation-sensitive layer of a calibration substrate a plurality of times to form by the lithographic process a plurality of calibration patterns, where different values of the process parameter are used to form different ones of the calibration patterns. The method continues by measuring the surface of the calibration substrate with a scanning electron beam microscope (SEM) to obtain a calibration measurement result for each calibration pattern on the calibration substrate, decomposing each of the measurement results into a set of basis functions and associated coefficients and obtaining a relationship between values of the coefficients and values of the parameter, and then projecting an image of the reference pattern onto a radiation-sensitive layer of a substrate to be tested so as to form a target pattern, wherein at least one value of the at least one process parameters used to form the target pattern is unknown. Furthermore, the method continues by measuring the surface of the substrate to be tested with a scanning electron beam microscope (SEM) configured to obtain a target measurement result for each target pattern on the substrate, and decomposing the target measurement result into a set of coefficients multiplying a plurality of basis functions, and determining at least one value of the at least one process parameter used to form the target pattern from the obtained relationship between values of the coefficients and values of the process parameter.

Another further embodiment of the present invention relates to a semiconductor device produced with the method described herein.

In another further embodiment of the present invention a system is provided for determining at least one process parameter value related to a lithographic process by which a marker structure has been applied on a product substrate, the system including an optical detection apparatus configured for obtaining calibration measurement data from at least one calibration marker structure set provided on a calibration substrate, a calibration marker structure set including at least one calibration marker structure created using different known values of at least one process parameter; and a processor unit configured for determining a mathematical model by using known values of the at least one process parameter and by employing a regression technique on the calibration measurement data, the mathematical model comprising a number of regression coefficients. Within the system, the optical detection apparatus is further configured for obtaining product measurement data from at least one product marker structure provided on the product substrate, with at least one product marker structure being exposed with an unknown value of said at least one process parameter; and where the procesor unit is further configured to determine the unknown value of at least one process parameter for the product substrate from the obtained product measurement data by employing regression coefficients of the mathematical model; where the optical detection apparatus comprises a scanning electron microscope (SEM) configured and arranged to determine one or more scanning electron microscope (SEM) images of the calibration substrate and the product substrate, the calibration measurement data and product measurement data being obtained from such images.

According to another embodiment of the present invention, a lithographic system comprising a lithographic apparatus in combination with a system as described herein is provided, for determining at least one process parameter value related to a lithographic process to be performed by the lithographic apparatus, the apparatus including an illumination system configured to provide a beam of radiation, a support structure configured to support a patterning structure, the patterning structure serving to impart the beam of radiation with a pattern in its cross-section, and a substrate table configured to hold the substrate; and a projection system configured to project the patterned beam onto a target portion of the substrate.

According to another embodiment of the present invention, obtaining calibration measurement data, determining a mathematical model, and determining the unknown value of a process parameter are accomplished in an automated fashion, thereby autmatedly performing such functions.

According to another embodiment of the present invention, a computer program product is provided, the product comprising instructions and data to allow a processor to run a predetermined program in accordance with any one of the methods as described herein. The invention also relates to a data carrier comprising the computer program product.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a lithographic cell or cluster according to an embodiment of the invention;

FIG. 3 depicts a scanning electron microscope (SEM) that may be used with the invention;

FIGS. 4a, 4b respectively depict a functional block diagram representing the calibration phase and measurement phase, according to an embodiment of the present invention;

FIG. 5 depicts an embodiment of a lithographic system according to an embodiment of the present invention;

FIG. 6. is a flow chart of a method according to an embodiment of the invention;

FIG. 7 is an image obtained using the scanning electron microscope of FIG. 3;

FIG. 8. depitcs the intensity profile derived from the image of FIG. 7;

FIG. 9 is representation of the set focus and the predicted focus value of the calibration substrate, using a 100 nm line with a pitch of 250 nm; and

FIG. 10 is representation of the set dose and the predicted dose value of the calibration substrate, using a 100 nm line with a pitch of 250 nm.

One or more embodiments of the present invention will now be described with reference to the accompanying drawings.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment cannot necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention can be implemented in hardware, firmware, software, or any combination thereof. Embodiments of the invention can also be implemented as instructions stored on a machine-readable medium, which can be read and executed by one or more processors. A machine-readable medium can include any mechanism for storing or transmitting information in a form readable by a machine (e.g.,, a computing device). For example, a machine-readable medium can include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions can be described herein as performing certain actions. However, it should be appreciated that such descriptions are merely for convenience and that such actions in fact result from computing devices, processors, controllers, or other devices executing the firmware, software, routines, instructions, etc.

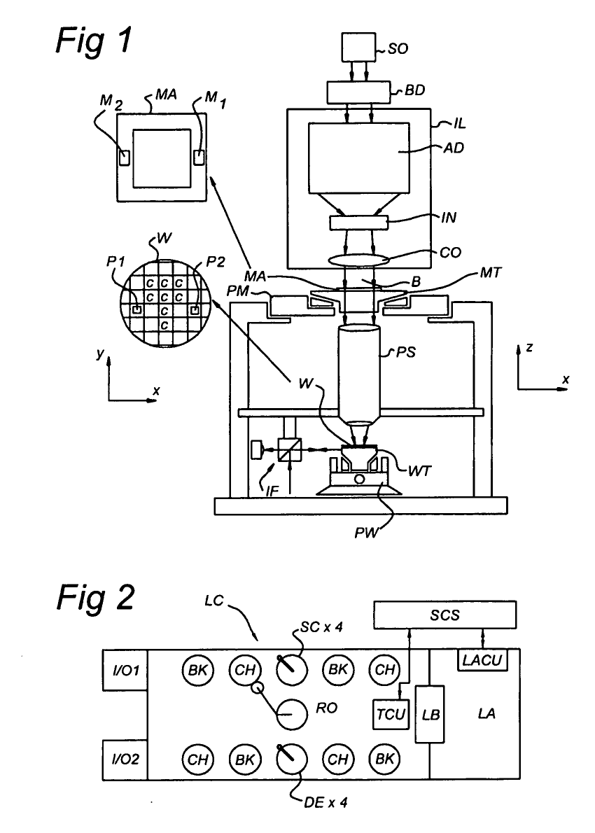

FIG. 1 schematically depicts a lithographic apparatus according to one embodiment of the invention. The apparatus comprises an illumination system (illuminator) IL configured to condition a radiation beam B (e.g., UV radiation or EUV radiation). A support (e.g., a mask table) MT configured to support a patterning device (e.g., a mask) MA and connected to a first positioner PM configured to accurately position the patterning device in accordance with certain parameters. A substrate table (e.g., a wafer table) WT is configured to hold a substrate (e.g., a resist coated wafer) W and is connected to a second positioner PW configured to accurately position the substrate in accordance with certain parameters. A projection system (e.g., a refractive projection lens system) PL configured to project a pattern imparted to the radiation beam B by patterning device MA onto a target portion C (e.g., comprising one or more dies) of the substrate W.

The illumination system may include various types of optical components, such as refractive, reflective, magnetic, electromagnetic, electrostatic or other types of optical components, or any combination thereof, to direct, shape, and/or control radiation.

The support supports, e.g., bears the weight of, the patterning device. It holds the patterning device in a manner that depends on the orientation of the patterning device, the design of the lithographic apparatus, and other conditions, such as for example whether or not the patterning device is held in a vacuum environment. The support can use mechanical, vacuum, electrostatic or other clamping techniques to hold the patterning device. The support may be a frame or a table, for example, which may be fixed or movable as required. The support may ensure that the patterning device is at a desired position, for example with respect to the projection system. Any use of the terms “reticle” or “mask” herein may be considered synonymous with the more general term “patterning device.”

The term “patterning device” used herein should be broadly interpreted as referring to any device that can be used to impart a radiation beam with a pattern in its cross-section such as to create a pattern in a target portion of the substrate. It should be noted that the pattern imparted to the radiation beam may not exactly correspond to the desired pattern in the target portion of the substrate, for example if the pattern includes phase-shifting features or so called assist features. Generally, the pattern imparted to the radiation beam will correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam, which is reflected by the mirror matrix.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein may be considered as synonymous with the more general term “projection system”.

As here depicted, the apparatus is of a transmissive type (e.g., employing a transmissive mask). Alternatively, the apparatus may be of a reflective type (e.g., employing a programmable mirror array of a type as referred to above, or employing a reflective mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

The lithographic apparatus may also be of a type wherein at least a portion of the substrate may be covered by a liquid having a relatively high refractive index, e.g., water, so as to fill a space between the projection system and the substrate. An immersion liquid may also be applied to other spaces in the lithographic apparatus, for example, between the mask and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring to FIG. 1, the illuminator IL receives radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source may be an integral part of the lithographic apparatus, for example when the source is a mercury lamp. The source SO and the illuminator IL, together with the beam delivery system BD if required, may be referred to as a radiation system.

The illuminator IL may comprise an adjuster AD for adjusting the angular intensity distribution of the radiation beam. Generally, at least the outer and/or inner radial extent (commonly referred to as a-outer and a-inner, respectively) of the intensity distribution in a pupil plane of the illuminator can be adjusted. In addition, the illuminator IL may comprise various other components, such as an integrator IN and a condenser CO. The illuminator may be used to condition the radiation beam, to have a desired uniformity and intensity distribution in its cross section.

The radiation beam B is incident on the patterning device (e.g.,, mask MA), which is held on the support (e.g., mask table MT), and is patterned by the patterning device. Having traversed the mask MA, the radiation beam B passes through the projection system PL, which focuses the beam onto a target portion C of the substrate W. With the aid of the second positioner PW and position sensor IF (e.g., an interferometric device, linear encoder or capacitive sensor), the substrate table WT can be moved accurately, e.g., so as to position different target portions C in the path of the radiation beam B. Similarly, the first positioner PM and another position sensor (which is not explicitly depicted in FIG. 1a) can be used to accurately position the mask MA with respect to the path of the radiation beam B, e.g., after mechanical retrieval from a mask library, or during a scan. In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (these are known as scribe-lane alignment marks). Similarly, in situations in which more than one die is provided on the mask MA, the mask alignment marks may be located between the dies.

The depicted apparatus could be used in at least one of the following modes:

1. In step mode, the mask table MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the mask table MT and the substrate table WT are scanned synchronously while a pattern imparted to the radiation beam is projected onto a target portion C (i.e. a single dynamic exposure). The velocity and direction of the substrate table WT relative to the mask table MT may be determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the mask table MT is kept essentially stationary holding a programmable patterning device, and the substrate table WT is moved or scanned while a pattern imparted to the radiation beam is projected onto a target portion C. In this mode, generally a, pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

As shown in FIG. 2, the lithographic apparatus LA may form part of a lithographic cell LC, also sometimes referred to a lithocell or cluster, which also includes apparatus to perform pre- and post-exposure processes on a substrate. Conventionally these include spin coaters SC to deposit resist layers, developers DE to develop exposed resist, chill plates CH and bake plates BK. A substrate handler, or robot, RO picks up substrates from input/output ports I/O 1 , I/O 2, moves them between the different process apparatus and delivers then to the loading bay LB of the lithographic apparatus. These devices, which are often collectively referred to as the track, are under the control of a track control unit TCU which is itself controlled by the supervisory control system SCS, which also controls the lithographic apparatus via lithographic control unit LACU. Thus, the different apparatus can be operated to maximize throughput and processing efficiency.

In order that the substrates that are exposed by the lithographic apparatus are exposed correctly and consistently, it is desirable to inspect exposed substrates to measure properties such as overlay errors between subsequent layers, line thicknesses, critical dimensions (CD), etc.. If errors are detected, adjustments may be made to exposures of subsequent substrates, especially if the inspection can be done soon and fast enough that other substrates of the same batch are still to be exposed. Also, already exposed substrates may be stripped and reworked, to improve yield or discarded, thereby avoiding performing exposures on substrates that are known to be faulty. In a case where only some target portions of a substrate are faulty, further exposures can be performed only on those target portions which are good.

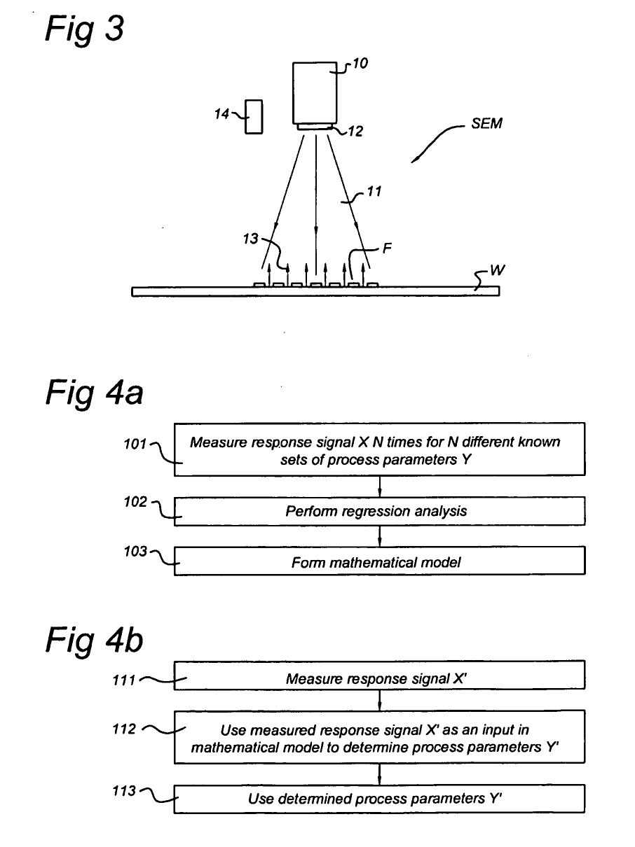

To this end an inspection apparatus is used to determine the properties of the substrates, and in particular, how the properties of different substrates or different layers of the same substrate vary from layer to layer. The inspection apparatus may be integrated into the lithographic apparatus LA or the lithocell LC or may be a stand-alone device. To enable most rapid measurements, it is desirable that the inspection apparatus measure properties in the exposed resist layer immediately after the exposure. An embodiment of an inspection device is discussed hereafter. FIG. 3 depicts schematically an electron microscope, more particularly a scanning electron microscope (SEM), that may image the surface of a substrate W (including the features F provided thereon) by scanning it with a beam of electrons. The beam 11 of electrons is generated by an electron source 10 of some kind, and is focused on the substrate, for instance using a magnetic lens 12. Preferably the substrate surface is scanned in a raster patterns, for instance in a pattern of a large number of substantially parallel lines. The electron beam 11 is directed to the substrate's surface and interacts with the atoms that make up the upper portion of the substrate W producing signals that contain information about the substrate's surface topography. The scanning electron microscope may produce images of the substrate by detecting low-energy secondary electrons 13 which are emitted from the surface of the substrate due to excitation by the primary electron beam 11, using one more detectors 14.

More specifically, the scanning electron microscope SEM may scan a target structure on a substrate W, for instance one or more marker structures on the surface or a device structure. The target on the substrate may be a grating which is printed such that after development, the bars are formed of solid resist lines. The bars may alternatively be etched into the substrate. The target pattern is chosen to be sensitive to a process parameter of interest, such as focus or dose, such that variations in the relevant process parameter will manifest themselves as variations in the printed target.

Generally, the process parameter(s) may be any parameter(s) that are representative of the properties of the substrate. However, in the following description of embodiments of the present invention, reference will be made to dose and focus as exemplary process parameters. It should be understood that embodiments of the invention may be applied in a similar fashion when other lithographic process parameters are used.

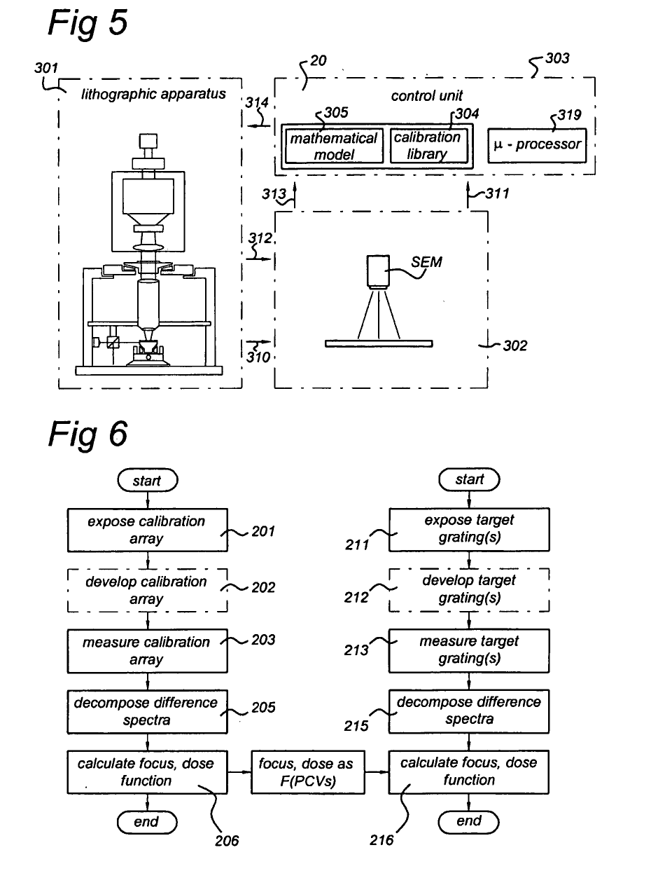

FIGS. 4a and 4b show functional block diagrams of an embodiment of the present invention. In this embodiment, calibration measurement data sets are used to form a mathematical model by employing a regression technique in a calibration phase. Then, the process parameters that were used to manufacture a real structure on a substrate to be measured upon or to be tested, also referred to as the target (structure) of a product substrate, can be derived by employing the obtained mathematical model in an operational phase. FIG. 4a depicts the method used in the calibration phase, in one such embodiment of the invention. The method starts at task 101, where calibration measurement data sets are measured with a number of calibration marker structures and stored in a memory 20 (cf. FIG. 5, to be described hereafter). These calibration structures are constructed with a known set of process parameters, which are different for each calibration structure. For example, when the process parameters are focus and dose, the method first measures the calibration structures with the scanning electron microscope SEM and stores the measured calibration measurement data sets in the memory 20.

The method then proceeds to task 102, where a regression analysis is performed on the stored calibration measurement data sets with a processor connected to the memory 10. This processor can be processor 319 in an embodiment of the invention or may be a different processor in other embodiments of the invention. Next the method proceeds to task 103, where a mathematical model is determined. The mathematical model defines a relationship between the calibration measurement data sets and the process parameters used to manufacture the calibration structure upon which the calibration measurement data sets are measured. The determined model may be stored in a memory, for instance memory 20 and/or a different memory, connected to the processor, in other embodiments of the invention.

FIG. 4b shows the method used in the actual measurement phase according to an embodiment of the invention. The method may be performed by the processor 319 in order to use the obtained model to derive the values of selected process parameters from measurements performed on a “real” structure on a substrate or, in embodiments of the invention, on a product substrate. The method starts in task 111, where a response signal is measured on the “real” structure on a substrate. The measured signal serves as an input for the model. The method then proceeds to task 112, where the desired values of the selected process parameters are determined. Next, the method proceeds to task 113, where the determined process parameters are used in the lithographic process, either manually or automatically, to correct, for example, external settings of the lithographic apparatus, like dose settings and/or focus settings.

According to embodiments of the present invention the method may be based on the principle that a signal can be described as a sum of a number of basis function or, in other words, eigenvectors or principal components, each of the principal components contributing to the signal with a certain weight factor, or, in other words a certain eigenvalue or score.. The number of principal components may vary considerably. Hereafter a more detailed description is given of the method according to embodiments of the invention wherein the regression analysis is the principal component analysis (PCA).

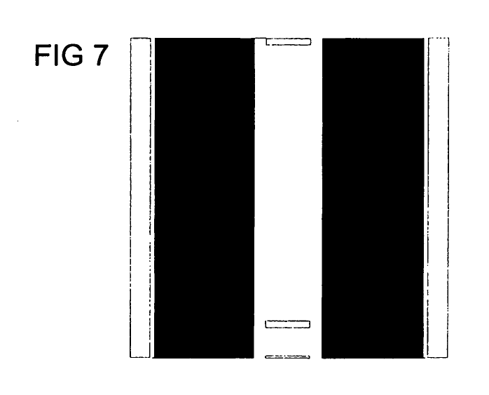

As shown in FIG. 6, in the calibration phase, a calibration marker structure, according to an embodiment, comprises one or more calibration markers and is printed a plurality of times in an array on the calibration substrate CW. Each different instance of the calibration marker structure is exposed at a different combination of focus and dose settings (201) and developed (202). Conveniently the instances are configured so that in one direction in the array, e.g., x, focus varies and in the other direction, e.g., y, dose varies. Such an arrangement is known as a focus-energy matrix (FEM). In other embodiments the variation of focus and dose is done in a random order to prevent inclusion of systematic errors that could occur due to systematic focus and dose changes.

In embodiments of the invention the inspection tool includes a scanning electron microscope (SEM) which is used to measure images of the calibration marker structures, (203) on the calibration susbstrate CW. The calibration substrate markers may take any form and may for instance include non-periodic features and complex features, e.g., contact holes or brick walls. By using a scanning electron microscope (SEM) typically features with a size as small as 40 nm or even 22 nm may be determined with sufficient accuracy.

Each calibration marker structure provides a respective SEM image. An example of a SEM image is shown in FIG. 7. In embodiments of the invention, the set of SEM images is then used as input for the principal component analysis. First the images are decomposed and expressed in a suitable set of basis functions (205). The number of basis functions used may vary and is dependent on the desired accuracy of the decomposition. In practice a number of two or three basis functions appears to give good results in terms of processing speed and accuracy of the decomposition. Next (206) the relationships between focus and dose values and principal component values are obtained. The obtained relationships may be stored in memory for later use, i.e. in ameasurement phase of the present method.

Similarly, the target substrate is scanned by the scanning electron microscope (SEM) and is subjected by corresponding process, also illustrated in FIG. 6. A product marker structure comprising markers that in an embodiment are identical in form to the calibration gratings, is exposed (211) onto the product substrate PW during the course of a production exposure. Next (213) the scanning electron microscope (SEM) is used to obtain product measurement data in the form of one or more SEM images of the product marker structure. As in the calibration process, the product measurement data are subjected to the earlier mentioned principal component analysis: the data are decomposed (215) into a set of coefficients (principal component values) from which can be obtained (216), using the stored relationship determined in the earlier calibration phase (206), the focus and dose values. As mentioned above, these relationships have previously been stored in a memory to which the scanning electron microscope (SEM) may be connected. In this way the focus and dose values may be determined when the product substrate involves features, more specifically marker structures that could otherwise not easily be measured with a scatterometer.

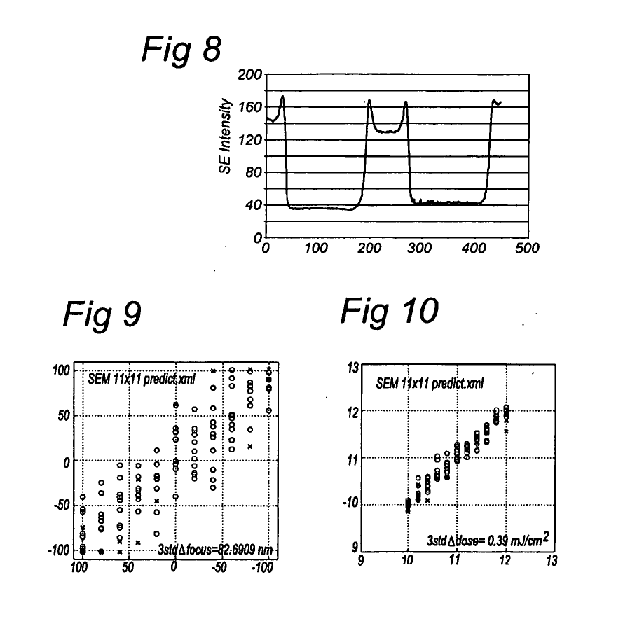

In further embodiments of the present invention, some kind of some kind of pre-processing may be applied before the calibration measurement data and/or product measurement date are subjected to the Principle Component Analysis and are fed into the model. Pre-processing can enhance the results of the method. For instance, if the measurement data are formed by an SEM image, the measurement data my be translated into an intensity profile as shown in FIG. 8 by averaging a plurality of lines of the SEM image. Other pre-processing operations may be applicable to the present invention as well.

In embodiments of the present invention, more than one type of marker structure can be used in both the calibration and measurement process. It may be desirable that the calibration substrate measurement and target substrate measurement be substantially identical in at least some respects (e.g.,, same pre-processing, same marker or combination of marker, and/or same substrate type).

In other embodiments at least one product marker structure and/or at least one calibration marker structure comprise different markers having different sensitivities to variation in the value of the process parameter. For instance, if focus is one of the process parameters that is measured using one of the embodiments disclosed herein, further optimization may be possible by increasing the sensitivity to focus changes. This may for instance be accomplished by using marker structures with more side wall, e.g., using markers having semi-isolated contact holes or semi-isolated dots.

It should be understood that any type of substrate, e.g., product wafers or test wafers, may be used in applications of embodiments of the present invention. It should also be understood that the actual, physical structure to be measured may be located anywhere on the substrate, e.g., within a chip area or a in a scribe-lane, as may be desirable in such application.

Starting from the intensity profile of a calibration substrate, for instance the intensity profile of a marker having 100 nm isolated lines with a pitch of 250 nm, as shown in FIG. 8 the maker being made with a known dose and focus value, a cross-check can be performed. In the manner described above a calibration substrate is used to determine the one or more principle components and the corresponding coefficients of the principle component model. When the method is applied again to the same intensity profile (namely de intensity profile of the calibration marker structure instead of the measurement marker structure), the associated focus and dose can be calculated. FIG. 9 shows the correlation between the setpoints for focus and dose in nm (i.e. the a priori known values) and the predicted values for focus and dose in nm. FIG. 10 shows the correlation between the setpoints for focus and dose in mJ/cm2 (i.e. the a priori known values) and the predicted values for focus and dose in mJ/cm2. From these figures, it is clear that there is a strong correlation between the determined and actual focus and dose for isolated lines. To further improve the accuracy several things can be done: The averaging could be done in a more elaborate way by using multiple intensity profiles. In embodiments of the invention the at least one product marker structure and/or the at least one calibration marker structure may comprise a first diffraction grating configured to provide a high focus sensitivity and a low dose sensitivity and a second diffraction grating configured to provide a low focus sensitivity and a high dose sensitivity. For instance, a first measurement data subset is formed by intensity profile data representative of one or more edges of a marker element for determining the associated focus value and a second measurement data subset is formed by intensity profile data representative of the width of a marker element for determining the associated exposure dose value. Both data sets are used to calculate the associated focus and dose values. More specifically, one of the intensity profiles would be the same as discussed in connection with FIG. 8, the other intensity profile would only include one edge of the SEM profile, as the edge is most sensitive to focus.

FIG. 5 depicts a lithography system according to an embodiment of the present invention. In this embodiment, the substrate, which is exposed with the lithographic apparatus 301, is transferred (after development by the track) to the scanning electron microscope 302. The scanning electron microscope 302 is connected to a control unit 303 that includes a processor 319 and a memory 20. The lithographic apparatus 301 first creates a FEM, by printing a marker structure, suitable for scatterometric measurements, using predetermined settings for the process parameters focus and dose. Then, the substrate is transported 310 to the scanning electron microscope 302. The scanning electron microscope 302 measures calibration measurement data sets and stores 311 the measured measurement data sets in a calibration library 304 of memory 20.

The lithographic apparatus 301 patterns a production substrate PW with the same marker structure. Then the substrate is transported 312 to scanning electron microscope 302. The scanning electron microscope 302 measures the topography of the production substrate, resulting in product measurement data that are fed (313) into the mathematical model 305 that can be used by processor 319. The mathematical model 305 is used by processor 319 to compare the calibration measurement data sets stored in calibration library 304, with the measured data on the marker structure and the processor 319 derives the values of the parameters to be controlled, like dose and focus, by employing a regression technique.

Finally the processor 319 supplies the derived values of these parameters to the lithographic apparatus 301. The lithographic apparatus 301 may use, for example, the derived values to monitor the drifts within the apparatus with respect to a reference state. The derived values are then used in feedback signals to correct for these drifts. In this case, the lithographic apparatus 301 is provided with a correction control unit, which uses the applied correction signals to compensate for drift. The correction control unit 303 may be configured to control, for example, the height of the substrate table WT to improve focus.

Although specific reference may be made in this text to the use of lithographic apparatus in the manufacture of ICs, it should be appreciated that the lithographic apparatus described herein may have other applications, such as the manufacture of integrated optical systems, guidance and detection patterns for magnetic domain memories, flat-panel displays, liquid-crystal displays (LCDs), thin film magnetic heads, etc. It should be appreciated that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers

Although specific reference may have been made above to the use of embodiments of the invention in the context of optical lithography, it should be appreciated that the invention may be used in other applications, for example imprint lithography, and where the context allows, is not limited to optical lithography. In imprint lithography a topography in a patterning device defines the pattern created on a substrate. The topography of the patterning device may be pressed into a layer of resist supplied to the substrate whereupon the resist is cured by applying electromagnetic radiation, heat, pressure or a combination thereof. The patterning device is moved out of the resist leaving a pattern in it after the resist is cured.

The terms “radiation” and “beam” used herein encompass all types of electromagnetic radiation, including ultraviolet (UV) radiation (e.g., having a wavelength of or about 365, 355, 248, 193, 157 or 126 nm) and extreme ultra-violet (EUV) radiation (e.g., having a wavelength in the range of 5-20 nm), as well as particle beams, such as ion beams or electron beams.

### Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

The descriptions above are intended to be illustrative, not limiting. Thus, it will be apparent to one skilled in the art that modifications may be made to the invention as described without departing from the scope of the claims set out below.

1. A method for determining at least one process parameter value related to a lithographic process by which a marker structure has been applied on a product substrate, the method comprising:
obtaining calibration measurement data, with an optical detection apparatus, from at least one calibration marker structure set provided on a calibration substrate, a calibration marker structure set including at least one calibration marker structure created using different known values of said at least one process parameter;
determining a mathematical model by using said known values of said at least one process parameter and by employing a regression technique on said calibration measurement data, said mathematical model comprising a number of regression coefficients;
obtaining product measurement data, with said optical detection apparatus, from at least one product marker structure provided on the product substrate, said at least one product marker structure being exposed with an unknown value of said at least one process parameter; and
determining the unknown value of said at least one process parameter for said product substrate from said obtained product measurement data by employing said regression coefficients of said mathematical model; wherein the optical detection apparatus comprises a scanning electron microscope (SEM) and wherein the obtained calibration measurement data and product measurement data comprise one or more images obtained by said scanning electron microscope (SEM).

2. The method of claim 1, wherein the measurement data are formed by intensity profile data derived from images obtained by the scanning electron microscope (SEM).

3. The method of claim 1, wherein obtaining calibration measurement data and/or product measurement data with scanning electron microscope (SEM) comprises scanning the associated marker structures with a beam of electrons and detecting the electrons after interaction with the marker structures.

4. The method of claim 1, wherein the regression technique used to obtain the mathematical model is a principal component analysis (PCA) technique.

5. The method of claim 1, wherein determining the mathematical model comprises:
decomposing the obtained measurement data from each of the product marker structures into a set of basis functions and associated regression coefficients and obtaining a relationship between values of the regression coefficients and values of the at least one process parameters.

6.-9. (canceled)

10. The method of claim 1, wherein said at least one process parameter is selected from a group comprising focus and exposure dose.

11. The method of claim 1, wherein the process parameters are focus and exposure dose used to provide the marker structure on the substrate.

12.-18. (canceled)

19. A method of measuring at least one process parameter of a lithographic process by which a target pattern has been printed on a substrate to be tested, the method comprising:
projecting an image of a reference pattern onto a radiation-sensitive layer of a calibration substrate a plurality of times to form by the lithographic process a plurality of calibration patterns, wherein different values of the process parameter are used to form different ones of the calibration patterns;
measuring the surface of the calibration substrate with a scanning electron beam microscope (SEM) to obtain a calibration measurement result for each calibration pattern on the calibration substrate;
decomposing each of the measurement results into a set of basis functions and associated coefficients and obtaining a relationship between values of the coefficients and values of the parameter;
projecting an image of the reference pattern onto a radiation-sensitive layer of a substrate to be tested so as top form a target pattern, wherein the at least one value of the at least one process parameter used to form the target pattern is unknown;
measuring the surface of the substrate to be tested with a scanning electron beam microscope (SEM) to obtain a target measurement result for each target pattern on the substrate;
decomposing the target measurement result into a set of coefficients multiplying a plurality of basis functions;
determining the at least one value of the at least one process parameter used to form the target pattern from said obtained relationship between values of the coefficients and values of the process parameter.

20.-22. (canceled)

23. System for determining at least one process parameter value related to a lithographic process by which a marker structure has been applied on a product substrate, the system comprising:
an optical detection apparatus configured for obtaining calibration measurement data from at least one calibration marker structure set provided on a calibration substrate, a calibration marker structure set including at least one calibration marker structure created using different known values of said at least one process parameter; and
a processor unit configured for determining a mathematical model by using said known values of said at least one process parameter and by employing a regression technique on said calibration measurement data, said mathematical model comprising a number of regression coefficients;
wherein the optical detection apparatus is further configured for obtaining product measurement data from at least one product marker structure provided on the product substrate, said at least one product marker structure being exposed with an unknown value of said at least one process parameter; and wherein the processor unit is further configured for determining the unknown value of said at least one process parameter for said product substrate from said obtained product measurement data by employing said regression coefficients of said mathematical model;
wherein the optical detection apparatus comprises a scanning electron microscope (SEM) configured and arranged to determine one or more scanning electron microscope (SEM) images of the calibration substrate and the product substrate, the calibration measurement data and product measurement data being obtained from said images.

24. The system of claim 22, wherein the optical detection apparatus and/or the processor unit are configured so as to derive intensity profile data from said images to obtain the calibration measurement data and product measurement data.

25. The system of as claimed in claim 21, wherein the scanning electron microscope (SEM) is configured so as to scan one or more marker structures with a high-energy beam of electrons and to detect the electrons after interaction with the marker structures.

26. The system of as claimed in claim 21, wherein the optical detection apparatus and/or the processor unit are configured so as to measure the measurement data and perform a preprocessing operation on the same.

27.-31. (canceled)

32. A method, comprising:
automatedly obtaining calibration measurement data based on an optical detection apparatus, from at least one calibration marker structure set provided on a calibration substrate, wherein the calibration marker structure set includes at least one calibration marker structure created using different known values of at least one process parameter; wherein the optical detection apparatus comprises a scanning electron microscope (SEM) and wherein the obtained calibration measurement data and product measurement data comprise one or more images obtained by said scanning electron microscope (SEM);
automatedly determining a mathematical model based on said known values of said at least one process parameter and by employing a regression technique on said calibration measurement data, said mathematical model comprising a number of regression coefficients;
obtaining product measurement databased on said optical detection apparatus, from at least one product marker structure provided on the product substrate, said at least one product marker structure being exposed with an unknown value of said at least one process parameter; and
automatedly determining the unknown value of said at least one process parameter for said product substrate from said obtained product measurement data by employing said regression coefficients of said mathematical model.

33. The method of claim 32, wherein the measurement data are formed by intensity profile data derived from images obtained by the scanning electron microscope (SEM).

34. The method of claim 32, wherein obtaining calibration measurement data and/or product measurement data with scanning electron microscope (SEM) comprises scanning the associated marker structures with a beam of electrons and detecting the electrons after interaction with the marker structures.

35. The method of claim 32, wherein the regression technique used to obtain the mathematical model is a principal component analysis (PCA) technique.

36. The method of claim 32, wherein determining the mathematical model further comprises decomposing the obtained measurement data from each of the product marker structures into a set of basis functions and associated regression coefficients and obtaining a relationship between values of the regression coefficients and values of the at least one process parameters.

37.-40. (canceled)

41. The method of claim 32, wherein said at least one process parameter is selected from a group comprising focus and exposure dose.

41. The method of claim 32, wherein the process parameters are focus and exposure dose used to provide the marker structure on the substrate.

43. The method of claim 32, wherein the at least one product marker structure and/or the at least one calibration marker structure are a part of a device pattern within a chip area.

44-48. (canceled)

49. A method, comprising:
projecting an image of a reference pattern onto a radiation-sensitive layer of a calibration substrate at least one or more times to form, by a lithographic process, one or more calibration patterns, wherein different values of a process parameter are used to form different ones of the calibration patterns;
measuring the surface of the calibration substrate with a scanning electron beam microscope (SEM) configured to obtain a calibration measurement result for each calibration pattern on the calibration substrate; decomposing each of the measurement results into a set of basis functions and associated coefficients and obtaining a relationship between values of the coefficients and values of the parameter;
projecting an image of the reference pattern onto a radiation-sensitive layer of a substrate to be tested so as to form a target pattern, wherein the at least one value of the at least one process parameter used to form the target pattern is unknown;
measuring the surface of the substrate to be tested with a scanning electron beam microscope (SEM) configured to obtain a target measurement result for each target pattern on the substrate;
decomposing the target measurement result into a set of coefficients multiplying a plurality of basis functions; and determining the at least one value of the at least one process parameter used to form the target pattern from said obtained relationship between values of the coefficients and values of the process parameter.

50. The method of claim 49, wherein, in forming the plurality of calibration patterns, two process parameters of the lithographic process are varied whereby a relationship between values of each of the process parameters and the coefficient values is obtained.

51. A system, comprising:
an optical detection apparatus configured for obtaining calibration measurement data from at least one calibration marker structure set provided on a calibration substrate, wherein the calibration marker structure set includes at least one calibration marker structure created using different known values of at least one process parameter; and
a processor unit configured for determining a mathematical model by using said known values of said at least one process parameter and by employing a regression technique on said calibration measurement data, said mathematical model comprising a number of regression coefficients;
wherein the optical detection apparatus is further configured for obtaining product measurement data from at least one product marker structure provided on the product substrate,
said at least one product marker structure being exposed with an unknown value of said at least one process parameter,
wherein the processor unit is further configured for determining the unknown value of said at least one process parameter for said product substrate from said obtained product measurement data by employing said regression coefficients of said mathematical model, and
wherein the optical detection apparatus comprises a scanning electron microscope (SEM) configured and arranged to determine one of more scanning electron microscope (SEM) images of the calibration substrate and the product substrate, the calibration measurement data and product measurement data being obtained from said images.

52. The system of claim 51, wherein the optical detection apparatus and/or the processor unit are configured so as to derive intensity profile data from said images to obtain the calibration measurement data and product measurement data.

53. The system of claim 51, wherein the scanning electron microscope (SEM) is configured so as to scan one or more marker structures with a high-energy beam of electrons and to detect the electrons after interaction with the marker structures.

54.-55. (canceled)

56. The system of claim 51, further comprising:
an illumination system configured to provide a beam of radiation;
a support structure configured to support a patterning structure, the patterning structure serving to impart the beam of radiation with a pattern in cross-section; and
a substrate table configured to hold the substrate; and a projection system configured to project the patterned beam onto a target portion of the substrate.

57. A computer program product comprising’ a computer readable medium having control logic stored thereon for causing a computer to determine at least one process parameter value related to a lithographic process, comprising:
first computer readable program code that causes the computer to obtain calibration measurement data based on an optical detection apparatus, from at least one calibration marker structure set provided on a calibration substrate, wherein the calibration marker structure set includes at least one calibration marker structure created using different known values of at least one process parameter; wherein the optical detection apparatus comprises a scanning electron microscope (SEM) and wherein the obtained calibration measurement data and product measurement data comprise one or more images obtained by said scanning electron microscope (SEM);
second computer readable program code that causes the computer to determine a mathematical model based on said known values of said at least one process parameter and by employing a regression technique on said calibration measurement data, said mathematical model comprising a number of regression coefficients;
third computer readable program code that causes the computer to obtain product measurement databased on said optical detection apparatus, from at least one product marker structure provided on the product substrate, said at least one product marker structure being exposed with an unknown value of said at least one process parameter; and
fourth computer readable program code that causes the computer to determine the unknown value of said at least one process parameter for said product substrate from said obtained product measurement data by employing said regression coefficients of said mathematical model.
